(19) United States
(12) Patent Application Publication
(10) Pub. No.: US 2006/0284844 A1
(43) Pub. Date: Dec. 21, 2006

(54) Computer mouse with noiseless button

(75) Inventors: Kuei-Jen Yen, Tucheng City (TW); Yuan-Biing Sung, Sansia Township (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/330,239

(22) Filed: Jan. 12, 2006

(30) Foreign Application Priority Data
Jun. 21, 2005 (TW) 094120658

(51) Int. Cl. G09G 5/08

(52) U.S. Cl. 345/163

(57) ABSTRACT

A computer mouse with noiseless button is disclosed. The computer mouse is charactered by using a shade to prevent light beam reception of a light receiver, so that the light receiver transmits the control signal to express whether the light is received or detected by the light receiver. The computer mouse further attends to the noise problems resulted from clicking buttons that constituted by metal resilient members. The computer mouse further extends the service life thereof by attending contact faults of the metal resilient plate resulted from oxidation and problems of surfacing process.

### BACKGROUND OF THE INVENTION

1. Field of the Invention

The present invention generally is related to a computer mouse with a noiseless button, more particularly, to a computer mouse used to transmit cursor position signal with computer programs.

2. Description of the Related Art

A button of computer mouse is used as means of pointing, confirming, and selecting in a computer program. A micro switch or tact switch as a structure of a button of a conventional computer mouse.

In conventional the computer mouse, a metal plate is transfigured to determine whether to form an electrical conductive path to a contact pad of the convention computer mouse, and therefore, an electrical signal is transmitted to execute a command of the computer mouse.

Some annoying noise, however, is occurred because of the transfiguration of the metal plate. Moreover, contact faults may also occurred because of oxidation and problems of surfacing process, and the service life of the conventional computer mouse may be shortened. Furthermore, when the metal plate contacts the contact pad, a delay time resulted from the duration of the metal being bended to approach the contact pad may affect the efficiency of the conventional computer mouse. As mentioned above, the conventional computer mouse with metal plate has several less favorable problems that should be improved.

### BRIEF SUMMARY OF THE INVENTION

The present invention provides a computer mouse with a noise less button. The computer mouse includes a housing, at least one optical shading device, and a circuit board. The housing includes at least one button and at least one resilient member, and the at least one resilient member disposed corresponding to the button for applying a resilience force correspondingly to the at least one button.

The at least one optical shading device includes a light emitter, a light receiver, and a shade. The light beam is emitted from the light emitter reaching to the light receiver. The shade disposed under the at least one button and between the light emitter and the light receiver. When depressing the at least one button, the shade optionally blocking or passing the light beam to allow the light receiver accordingly producing a respective control signal.

The circuit board includes a micro processor electrically connected to the light receiver of the at least one optical shading device. The micro processor receiving the respective control signal from said light receiver and transmitting a corresponding signal.

The light receipt of the light receiver is controlled by depressing the button for driving the shade, and therefore, the control signal will be transferred to express whether the light is received by the light receiver. Accordingly, in the present invention, the computer mouse thoroughly removed the annoying noise from conventional computer mouse; and extends the service life thereby conventional computer mouse attending contact faults of the metal resilient plate resulted from oxidation and problems of surfacing process. In addition, the computer mouse, in the present invention, reduces the lag of the metal resilient plate being bended to approach and to contact the contact pad, and the efficiency of the computer mouse is improved significantly.

In the present invention, the resilient member includes a resilient beam, a spring, or other devices made of resilient materials.

In addition, the light emitter, in the present invention, further includes a light emitting diode or other light emitting devices.

Moreover, the light receiver, on the present invention, includes a phototransistor (PTR).

Furthermore, the shade and the button may be in integral.

### BRIEF DESCRIPTION OF THE DRAWINGS

FIG. 1 shows a computer mouse with a noiseless button of an embodiment of the present invention.

FIG. 2 shows a detailed view of a computer mouse of another embodiment of the present invention.

### DESCRIPTION OF THE EMBODIMENTS

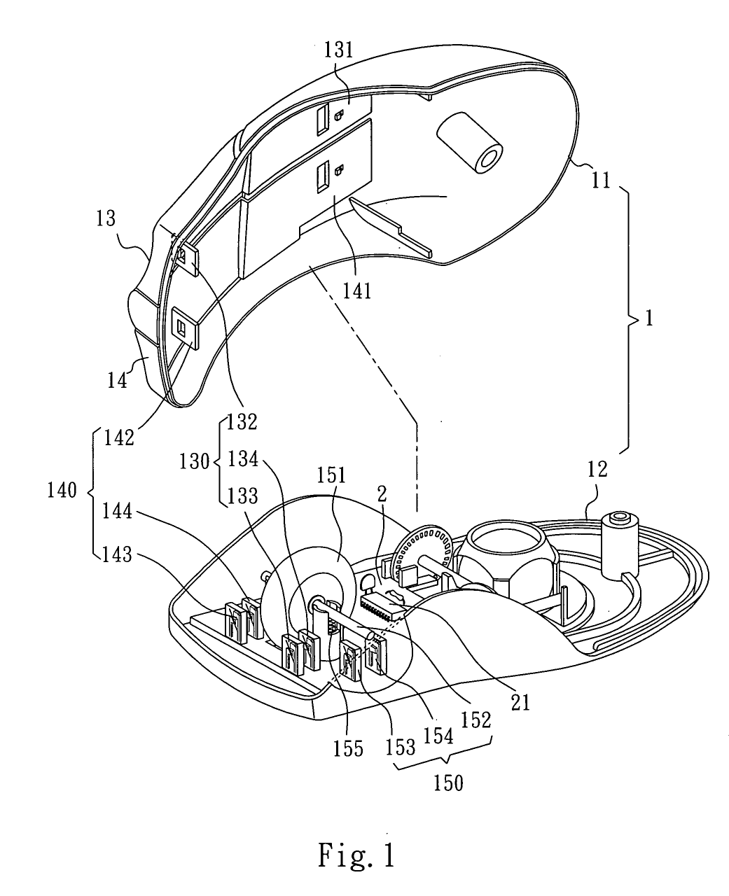

FIG. 1 shows a computer mouse with a noiseless button of an embodiment of the present invention. As shown in FIG. 1, the computer mouse includes a housing 1, three optical shading devices 130, 140, 150, and a circuit board 2.

The housing has a cover 11 and a base 12. Two buttons 13, 14 mounts on the cover 11, wherein two resilient beams 131, 141 respectively extend from the buttons 13, 14 for applying a resilience force to the buttons 13, 14 so that the buttons 13, 14 may return to the initial positions thereof.

The optical shading devices 130, 140, in the present embodiment, include two light emitters 133, 143, two light receivers 134, 144, and two shades 132, 142. The light emitters 133, 143 respectively include a light emitting diode emitting light beam reaching to the light receivers 133, 144, wherein each of the light receivers 133, 144 includes a phototransistor. The shades 132, 142 are disposed between the light emitters 133, 143 and the light receivers 134, 144 and under the buttons 13, 14. Two openings are correspondingly formed on the shades 132, 142. When the buttons 13, 14 are pressed, the light beam is allowed to pass through the corresponding openings of the shades 132, 142. When the buttons 13, 14 return to an initial position, the shades 132, 142 cut the light beam off, and the light receivers 134, 144 are not capable of receiving the light beam from the light emitters 133, 143. As a result, the light receivers 134, 144 transmit different control signals to express whether each of the light receivers 134, 144 receives the light beam and to detect whether the buttons 13, 14 are pressed.

The circuit board 2, in the present embodiment, includes a micro processor 21. The micro processor 21 is electrically connected to the light receivers 134, 144 of the optical shading devices 130, 140. The micro processor 21 receiving the respective control signal from the light receivers 134, 144 and transmitting a corresponding signal.

In addition, the button, in the embodiment, further includes a wheel 151 and another optical shading device 150. The optical shading device 150 includes a central shaft 152, a light emitter 153, and a light receiver 154. The central shaft 152 is pivoted on the axis of the wheel 151. A spring 155 is disposed under the central shaft 152 as support of the central shaft 152. An end of the central shaft extends between the light emitter 153 and the light receiver 154 to optionally cut the light beam off.

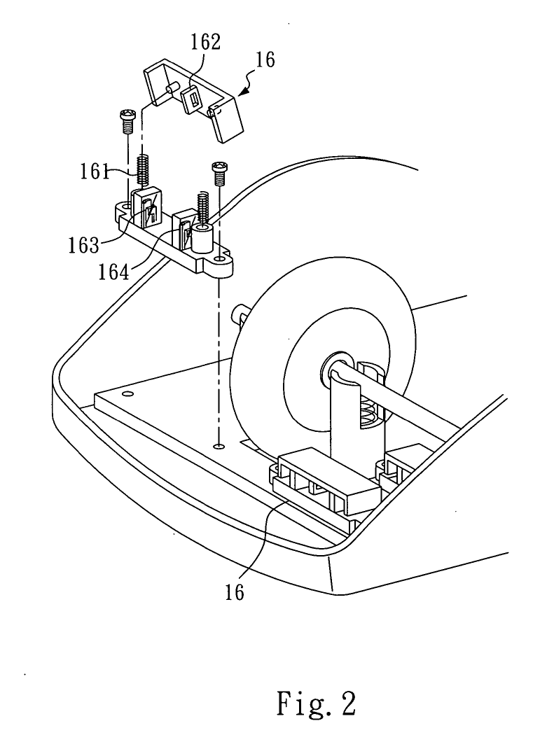

FIG. 2 shows a detailed view of a computer mouse of another embodiment of the present invention. As shown in FIG. 2, the general idea of the structure of the computer mouse in the embodiment is described above, and however, the computer mouse in the embodiment is charactered as that a resilient member 161, a shade 162, a light emitter 163, and a light receiver 164 are modulized into an optical shading module 16. As a result, the integrated construction of the computer mouse may reduce the cost and duration of the assembly of the computer mouse.

Other embodiments of the present invention will be apparent to those skilled in the art from consideration of the specification and practice of the present invention disclosed herein. It is intended that the specification and examples be considered as exemplary only, with a true scope and spirit of the present invention being indicated by the following claims.

What is claimed is:

1. A computer mouse with a noiseless button comprising:
a housing having at least one button and at least one resilient member, the at least one resilient member disposed corresponding to the at least one button and applying a resilience force correspondingly to the at least one button;
at least one optical shading device having a light emitter, a light receiver, and a shade, the light emitter emitting a light beam reaching to the light receiver, the shade of said at least one optical shading device disposed under the at least one button and between the light emitter and the light receiver, the shade optionally blocking or passing the light beam when depressing the at least one button to allow the light receiver accordingly producing a respective control signal; and
a circuit board having a micro processor electrically connected to the light receiver of the at least one optical shading device, the micro processor receiving the respective control signal from said light receiver and transmitting a corresponding signal.

2. The computer mouse of claim 1, wherein the shade of said at least one optical shading device is mounted under the at least one button in integral.

3. The computer mouse of claim 1, wherein the at least one resilient member of the housing includes a resilient beam.

4. The computer mouse of claim 1, wherein the light emitter of the at least one optical shading device includes a light emitting diode.

5. The computer mouse of claim 1, wherein the light receiver of the at least one optical shading device includes a phototransistor.

6. The computer mouse of claim 1, wherein the at least one button includes a wheel and a central shaft pivoted on the axis of the wheel, the at least one resilient member includes a spring to support the central shaft, an end of the central shaft includes the shade and extends between the light emitter and the light receiver.

7. The computer mouse of claim 1, wherein the light emitter, the light receiver, the resilient member and the shade are modulized into an optical shading module.
